(19) United States
(12) Patent Application Publication
(10) Pub. No.: US 2005/0108103 A1
(43) Pub. Date: May 19, 2005

(54) Prospect qualifying calculator

(76) Inventors: Roland L. Roberts, Dallas, TX (US); Tracey Hinkle, Plano, TX (US); Lenore Weich, Allen, TX (US); Guarav Suri, Menlo Park, CA (US); Jessica Hymowitz, Austin, TX (US); Guido Goyeneche, Santiago de Chile (CL)

Correspondence Address: THE LAW OFFICE OF STEPHEN R. LOE, P.O. Box 649, Frisco, TX, 75034, US

(21) Appl. No.: 10/716,272

(22) Filed: Nov. 18, 2003

(51) Int. Cl. G06F 17/60

(52) U.S. Cl. 705/26

(57) ABSTRACT

A method, system, and computer program product for determining whether to attempt to sell a product or service to a potential client is provided. In one embodiment, a set of criteria questions identified as being important in determining whether to attempt to sell the offering to the potential client are determined. Then a set of possible answers to each of the criteria questions is also determined. A respective criteria question weighting factor is assigned to each criteria question and an answer weighting factor is assigned to each potential answer for each respective criteria question. Answers to each of the criteria questions are determined and a qualifying score is calculated. The qualifying score allows different potential clients to be compared to one another as to which is more likely to be receptive to the offered product or service and allows determinations as to which potential customers to target for attempted sale of the product or service in a systematic and repeatable fashion.

### BACKGROUND OF THE INVENTION

1. Technical Field

The present invention relates generally to computer software and, more particularly, to business methods of marketing products.

2. Description of Related Art

Businesses that develop and market products to be sold to other businesses make up a sizeable portion of the modern economy. When the products to be sold are relatively inexpensive or generic, determining which businesses to market the product to may be rather simple. For example, if the product is paper, then the product may be marketed to businesses in general without focusing on a specific industry or targeted business.

However, there are many products or services on the market whose costs are in the millions or potentially billions and whose markets are rather narrow. These products and services require that the targeted potential clients be approached directly and marketing efforts customized for each potential client. Thus, significant man power and resources are expended on each potential client in an attempt to have the potential client purchase the product or service. Therefore, although the market for these products and services may be narrow, it still may number in the 100′s or 1000′s, and therefore, marketing may still represent a significant outlay of money and resources for the business selling the product or service.

Because businesses do not have unlimited resources to devote to marketing these products, decisions must be made as to which potential customers to approach so as to maximize the number of sales and minimize the cost of marketing. For example, a company would not want to spend millions of dollars marketing a product to a potential customer if it is known that that customer has little or no interest and will likely not buy the product regardless of the amount of time and energy spent marketing the product to this potential customer. In the past, these decisions were made in a rather ad hoc fashion without any methodology relying simply on “gut” feelings and experience by those in marketing as to what potential customers were worth expending marketing efforts on. However, such a method is not efficient. Therefore, it would be desirable to have a more systematic method for determining which potential customers to expend marketing resources on when selling a product or service.

### SUMMARY OF THE INVENTION

The present invention provides a method, system, and computer program product for determining whether to attempt to sell a product or service to a potential client. In one embodiment, a set of criteria questions identified as being important in determining whether to attempt to sell the offering to the potential client are determined. Then a set of possible answers to each of the criteria questions is also determined. A respective criteria question weighting factor is assigned to each criteria question and an answer weighting factor is assigned to each potential answer for each respective criteria question. Answers to each of the criteria questions are determined and a qualifying score is calculated. The qualifying score allows different potential clients to be compared to one another as to which is more likely to be receptive to the offered product or service and allows determinations as to which potential customers to target for attempted sale of the product or service in a systematic and repeatable fashion.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the present invention may be implemented;

FIG. 2 depicts a schematic diagram illustrating an exemplary research methodology to apply to a prospect qualifying calculator in accordance with one embodiment of the present invention;

FIG. 3 depicts a diagram illustrating a broad overview of program function and process flow for a prospect qualifying calculator in accordance with one embodiment of the present invention;

FIG. 4 depicts a diagram illustrating in more detail an exemplary program function and process flow for a prospect qualifying calculator in accordance with one embodiment of the present invention; and

FIG. 5 depicts an exemplary graphical user interface for use with a prospect qualifying calculator in accordance with one embodiment of the present invention.

### DETAILED DESCRIPTION OF THE PREFERRED EMBODIMENT

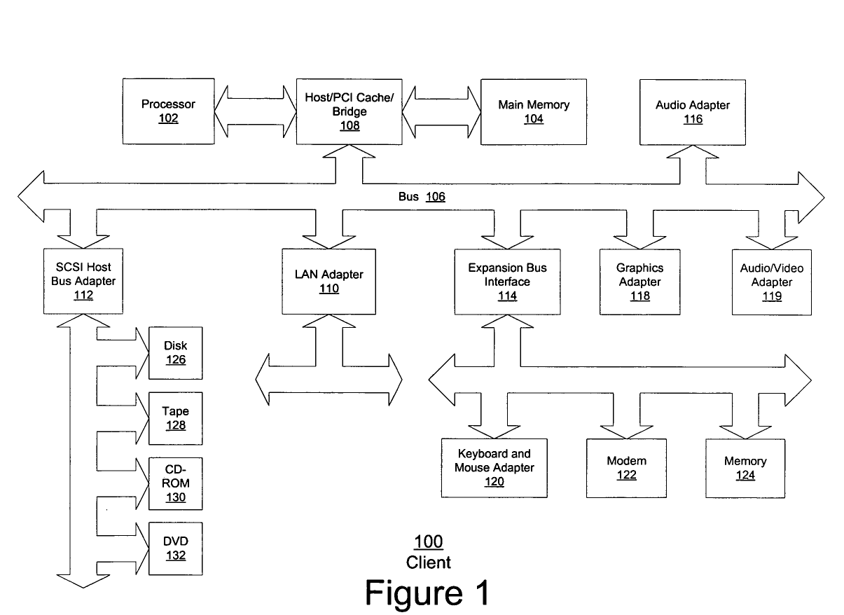

With reference now to the Figures and, in particular, with reference to FIG. 1, a block diagram of a data processing system in which the present invention may be implemented is illustrated. Data processing system 100 may be utilized to implement a prospect qualifying calculator in accordance with the present invention. A prospect qualifying calculator calculates, based on rules determined by a business enterprise and user input, prospect scores for each of a plurality of potential clients. The prospect score allows the business enterprise to evaluate the likelihood that the product or service offering would be acceptable or valuable to a potential client as well as allows comparisons between potential clients as to which would be more likely to desire the offered product or service.

Turning now to the physical details of data processing system 100, data processing system 100 employs a peripheral component interconnect (PCI) local bus architecture. Although the depicted example employs a PCI bus, other bus architectures, such as Micro Channel and ISA, may be used. Processor 102 and main memory 104 are connected to PCI local bus 106 through PCI bridge 108. PCI bridge 108 may also include an integrated memory controller and cache memory for processor 102.

Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter (A/V) 119 are connected to PCI local bus 106 by add-in boards inserted into expansion slots. Expansion bus interface 114 provides a connection for a keyboard and mouse adapter 120, modem 122, and additional memory 124. In the depicted example, SCSI host bus adapter 112 provides a connection for hard disk drive 126, tape drive 128, CD-ROM drive 130, and digital video disc read only memory drive (DVD-ROM) 132. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system, such as Windows XP, which is available from Microsoft Corporation of Redmond, Washington. “Windows XP” is a trademark of Microsoft Corporation. An object oriented programming system, such as Java, may run in conjunction with the operating system, providing calls to the operating system from Java programs or applications executing on data processing system 100. Instructions for the operating system, the object-oriented operating system, and applications or programs are located on a storage device, such as hard disk drive 126, and may be loaded into main memory 104 for execution by processor 102.

A prospect qualifying calculator runs in the operating system. The code and relevant data for the prospect qualifying calculator or stored on disk 126 and code is loaded into main memory 104 for execution by processor 102 when the prospect qualifying calculator is selected to run by a user. Relevant data for the prospect qualifying calculator may include a database of statistics and data concerning one or more of potential client businesses. For example, the database may include the identity of each of the Fortune 500 Corporations, the relevant business or businesses, the total revenues, and the amount of money spent on various types of resources by each of these corporations. The database may also include the amount of business each of these corporations did with the business enterprise utilizing the prospect qualifying calculator.

Those of ordinary skill in the art will appreciate that the hardware in FIG. 1 may vary depending on the implementation. For example, other peripheral devices, such as optical disk drives and the like, may be used in addition to or in place of the hardware depicted in FIG. 1. The depicted example is not meant to imply architectural limitations with respect to the present invention. For example, the processes of the present invention may be applied to multiprocessor data processing systems or may be implemented in a distributed data processing system to be accessible by users in differing locations from different data processing systems.

To determine the rules that should be implemented by the prospect qualifying calculator, people within the business entity must create of list of relevant considerations that must be taken into account when determining whether to target a potential client for sales and marketing efforts directed towards selling that potential client a service or product offered by the business entity. For example, the people within the business entity may identify financial stability of the potential client, whether the potential client is an existing client of the business enterprise, the line of businesses conducted by the potential client, perceived need for the offered product or service by the potential client, as well as any number of other factors. The factors may number in the hundreds or even thousands. Once the list of relevant considerations are determined, the list should be evaluated using, for example, Delphi or other brainstorming techniques, to reduce the number of considerations down to a few (e.g., 10 or 20) most important considerations.

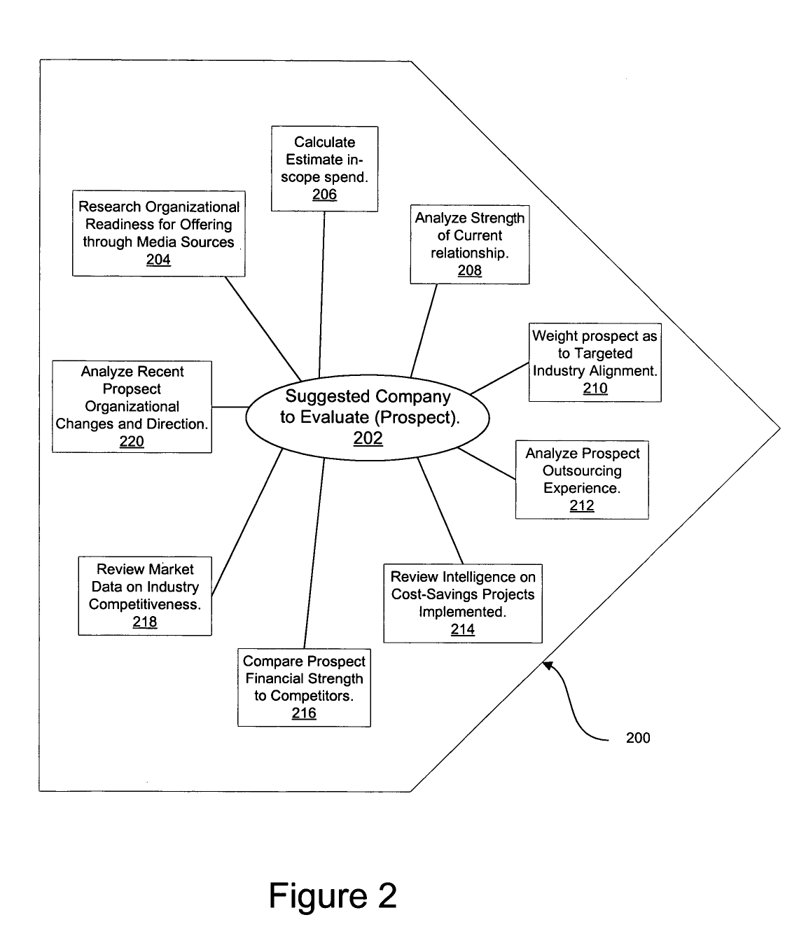

Referring to FIG. 2, a schematic diagram illustrating an exemplary research methodology 200 to apply to a prospect qualifying calculator is depicted in accordance with one embodiment of the present invention. The final list of most important considerations determined above may look like that depicted in FIG. 2 with each of the prospected clients 202 evaluated according to each of the several criteria 204-220. For example, in the scenario depicted in FIG. 2, the relevant criteria determined by the business are research organizational readiness for offering through media sources 204, calculate estimate in-scope spend 206, analyze strength of current relationship 208, weight prospective clients as to targeted industry alignment, analyze prospective client's outsourcing experience 212, review intelligence on cost-savings projects implemented 214, compare prospective client's financial strength to competitors 216, review market data on industry competitiveness 218, and analyzer recent prospective client organizational changes and direction 220.

The relative importance (i.e., weighting factors) for each of the criteria is then determined. The total of each of the weighting factors should equal 100%. Furthermore, the possible options for answers to each of the criteria are determined and weights assigned to each possible answer as to whether that answer increases or decreases the likelihood that the offering would be valuable and acceptable to the potential client. Once the user has indicated an answer to a question, a score is assigned to that question. Once each questions has been answered the scores of for each answer are weighted and added together. Thus, if the best answer is chosen for each criteria, the total score would be 100% indicating that the potential client is an excellent candidate to direct marketing efforts toward in hoped of selling the offered product or service.

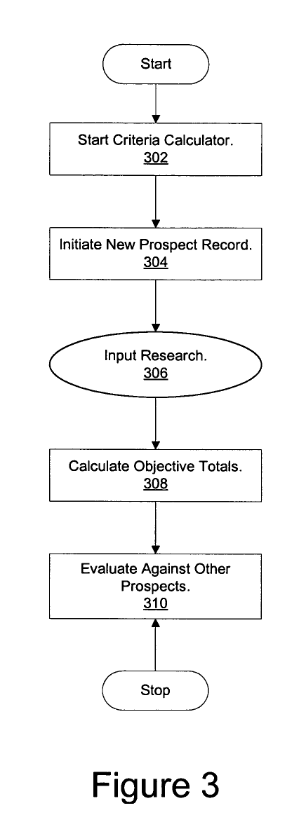

With reference now to FIG. 3, a diagram illustrating a broad overview of program function and process flow for a prospect qualifying calculator is depicted in accordance with one embodiment of the present invention. A user starts the criteria calculator of the prospect qualifying calculator (step 302) and initiates a new prospect record (step 304). The user then inputs research (e.g., answers questions to the questions related to the identified most important criteria) (step 306). Based on the weighting factors and rules identified by the business entity, the prospect qualifying calculator calculates objective totals for the potential client (step 308). The objective score can then be used to compare the potential client against other prospects (step 310).

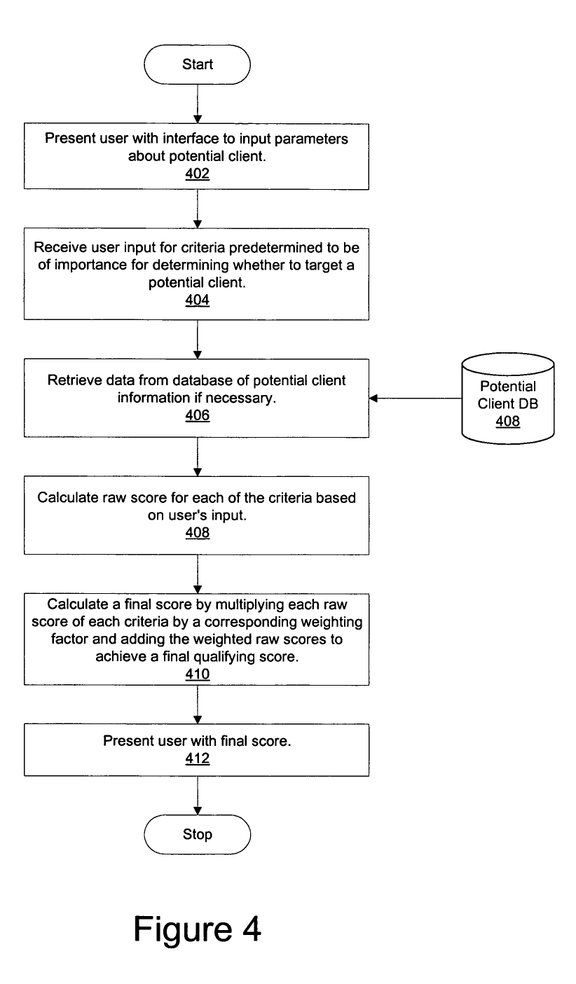

With reference now to FIG. 4, a diagram illustrating in more detail an exemplary program function and process flow for a prospect qualifying calculator is depicted in accordance with one embodiment of the present invention. The processes and functions depicted in FIG. 4 may be implemented, for example, in data processing system 100 in FIG. 1.

To begin, a user is presented with a user interface, preferably a graphical user interface, to input parameters about a potential client (step 402). The prospect qualifying calculator receives user input as to the identity of the potential client and for criteria predetermined to be of importance for determining whether to target a potential client (step 404). Based on the user input, the prospect qualifying calculator may retrieve data from a potential client database 408, if further information is needed to complete the acquisition of raw data needed by the prospect qualifying calculator in order to calculate a qualifying score (step 406). For example, certain criteria determined to be relevant may be answerable merely by knowing the identity of the potential client and looking up statistics associated with the potential client. For example, if a database of statistics concerning all Fortune 500 companies is maintained and one of the relevant criteria used to calculate a qualifying score is total revenue from a certain line of business, this information may e obtained from the database merely by the user identifying the potential client without the user having to input the answer to the specific question.

Once the answers to the criteria have been input into the prospect qualifying calculator, the prospect qualifying calculator calculates a raw score for each of the criteria (step 408). The prospect qualifying calculator then calculates a final qualifying core by multiplying each raw score of each criteria by its corresponding weighting factor and then adding the weighted scores (step 410). The user is then presented with the final qualifying score (step 412).

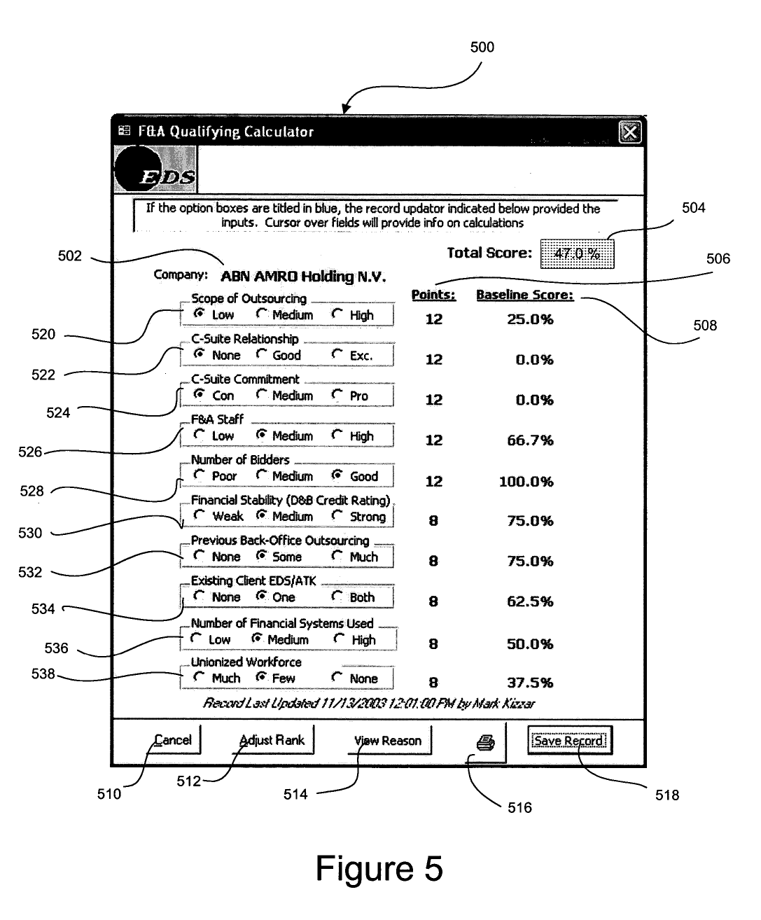

With reference now to FIG. 5, an exemplary graphical user interface for use with a qualifying prospect calculator is depicted in accordance with one embodiment of the present invention. Graphical User Interface (GUI) 500 displays the name of the company 502 being evaluated which was entered by a user in previous screen not shown. Each of the criteria questions 520-538 identified as important in determining whether to target a prospective client are displayed as well as the possible answers to the questions 520-530. In the depicted example, each criteria question 520-538 has three possible answers. However, in other embodiments, different criteria questions may have differing numbers of possible answers. For example, one criteria question could have two possible answers, a second criteria question could have three possible answers, and a third criteria question could have five possible answers.

In the depicted example, each criteria question 520-538 has been answered with a darkened bubble indicating the answer. The bubbles for the criteria questions 520-538 may have been darkened because of selection by a user or because the prospect qualifying calculator determined the answer to the question from a database. However, the user may override the prospect qualifying calculator. Thus, if the user has information that is not in the database or is more recent than the database, the prospect calculator may calculate the qualifying score based on the more accurate information.

The total possible points 506 available for each criteria question 520-538 is indicated beside the corresponding criteria question 520-538. For example, the total points available for criteria question 520 is 12. The total points 506 available for a criteria question 520-538 is the weighting factor. Thus, the total points 506 for each criteria question 520-538, if added together, total to 100.

The baseline score 508 for each criteria question 520-538 is indicated next to the corresponding criteria question 520-538 is indicated in FIG. 5. The baseline score 508 for a criteria question 520-538 is the relative portion of the total points 506 for the criteria question 520-538 that is awarded for the answer provided to the criteria question 520-538. For example, the answer to criteria question 520 was “low” which resulted in a baseline score 508 of 25.0%. Thus, the total points contributed toward the final total score 504 from criteria question 520 is 3 (e.g., 12 points multiplied by a baseline score of 25.0%).

The total score 504 for the company 502 is indicated as depicted in FIG. 5. It is calculated by multiplying the baseline score 508 for each criteria question 520-538 by the corresponding number of points 506 available for the corresponding criteria question 520-538 and then adding these products together. Thus, the total score for the company 502 illustrated in FIG. 5 is 47.0%. {Roland, your picture had a total score of 41.0%. However, when I multiplied each point by its respective baseline score and added these together, I came up with the 47.0% result. Therefore, I modified the picture to reflect this result. Am I correct in making this modification, or have I miss added or misunderstood the invention? Thanks.}

GUI 500 also provides a button 510 to cancel or abort the session if a user so desires, a button 512 to adjust the rank of the company 502, a button 514 to view the reason for a manually-changed score, a button 516 to print the screen, and a button 518 to save the record for the company 502. In some embodiments, the total score 504 may be shaded with different colors to indicate whether the score for the company 502 indicates that marketing efforts should be pursued or not. For example, threshold total scores could be set indicating whether to pursue a contract with a company, not pursue a contract, or a gray area where it might be advantageous to pursue contracting with the potential client to provide the offered service or product. Thus, different colors for the total score 504 could indicate which of the three options to pursue with green indicating to pursue a contract, yellow indicating that it might be profitable to pursue contracting, and red indicating that it is not worth pursuing a contract with the indicated potential client 502. Of course, other graphical indications could be utilized to indicate whether the total score 504 indicates that a contract with the potential client 502 is worth pursuing. For example, a graphic of a stop light with the appropriate one of the red, yellow, and green lights illuminated could by utilized.

GUI 500 is presented as an example of a GUI that could be utilized in conjunction with a prospect qualifying calculator and is not intended to imply any user face limitations to the present invention. Those skilled in the art will recognize that many changes and modifications could be made to GUI 500 without departing from the intent and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for determining whether to attempt to sell an offering to a potential client, the method comprising:
determining a set of criteria questions identified as being important in determining whether to attempt to sell the offering to the potential client;
determining a set of possible answers to each of the criteria questions;
assigning a respective criteria question weighting factor to each criteria question;
assigning an answer weighting factor to each potential answer for a respective criteria question;
determining answers to each of the criteria questions; and
calculating a qualifying score.

2. The method as recited in claim 1, wherein the answers to at least some of the criteria questions are determined via user input.

3. The method as recited in claim 1, wherein the answers to at least some of the criteria questions are determined by referencing a database of potential customer information.

4. The method as recited in claim 3, wherein a user may override answers supplied from the database of potential customer information.

5. The method as recited in claim 1, wherein the sum of weighting factors for each of the criteria questions equals one hundred percent.

6. The method as recited in claim 1, wherein a criteria question raw score for a selected one of the criteria questions is calculated by multiplying the answer weighting factor corresponding to the answer selected for the selected one of the criteria questions by the criteria question weighting factor for the selected one of the criteria questions.

7. The method as recited in claim 6, wherein the qualifying score is calculated by adding each of the criteria question raw scores together.

8. The method as recited in claim 1, further comprising:
specifying ranges of qualifying scores and actions to be taken corresponding to each range;
determining the range in which the qualifying score falls; and
presenting the user with a graphical indication indicating which range the qualifying score falls.

9. The method as recited in claim 8, wherein the graphical indication comprises coloring a box containing the qualifying score on a user display with a color which indicates which of the ranges the qualifying score falls.

10. A computer program product in a computer readable media for use in a data processing system for determining whether to attempt to sell an offering to a potential client, the computer program product comprising:
first instructions for determining a set of criteria questions identified as being important in determining whether to attempt to sell the offering to the potential client;
second instructions for determining a set of possible answers to each of the criteria questions;
third instructions for assigning a respective criteria question weighting factor to each criteria question;
fourth instructions for assigning an answer weighting factor to each potential answer for a respective criteria question;
fifth instructions for determining answers to each of the criteria questions; and
sixth instructions for calculating a qualifying score.

11. The computer program product as recited in claim 10, wherein the answers to at least some of the criteria questions are determined via user input.

12. The computer program product as recited in claim 10, wherein the answers to at least some of the criteria questions are determined by referencing a database of potential customer information.

13. The computer program product as recited in claim 12, wherein a user may override answers supplied from the database of potential customer information.

14. The computer program product as recited in claim 10, wherein the sum of weighting factors for each of the criteria questions equals one hundred percent.

15. The computer program product as recited in claim 10, wherein a criteria question raw score for a selected one of the criteria questions is calculated by multiplying the answer weighting factor corresponding to the answer selected for the selected one of the criteria questions by the criteria question weighting factor for the selected one of the criteria questions.

16. The computer program product as recited in claim 15, wherein the qualifying score is calculated by adding each of the criteria question raw scores together.

17. The computer program product as recited in claim 10, further comprising:
seventh instructions for specifying ranges of qualifying scores and actions to be taken corresponding to each range;
eighth instructions for determining the range in which the qualifying score falls; and
ninth instructions for presenting the user with a graphical indication indicating which range the qualifying score falls.

18. The computer program product as recited in claim 17, wherein the graphical indication comprises coloring a box containing the qualifying score on a user display with a color which indicates which of the ranges the qualifying score falls.

19. A system in a computer readable media for use in a data processing system for determining whether to attempt to sell an offering to a potential client, the system comprising:
first means for determining a set of criteria questions identified as being important in determining whether to attempt to sell the offering to the potential client;
second means for determining a set of possible answers to each of the criteria questions;
third means for assigning a respective criteria question weighting factor to each criteria question;
fourth means for assigning an answer weighting factor to each potential answer for a respective criteria question;
fifth means for determining answers to each of the criteria questions; and
sixth means for calculating a qualifying score.

20. The system as recited in claim 19, wherein the answers to at least some of the criteria questions are determined via user input.

21. The system as recited in claim 19, wherein the answers to at least some of the criteria questions are determined by referencing a database of potential customer information.

22. The system as recited in claim 21, wherein a user may override answers supplied from the database of potential customer information.

23. The system as recited in claim 19, wherein the sum of weighting factors for each of the criteria questions equals one hundred percent.

24. The system as recited in claim 19, wherein a criteria question raw score for a selected one of the criteria questions is calculated by multiplying the answer weighting factor corresponding to the answer selected for the selected one of the criteria questions by the criteria question weighting factor for the selected one of the criteria questions.

25. The system as recited in claim 24, wherein the qualifying score is calculated by adding each of the criteria question raw scores together.

26. The system as recited in claim 19, further comprising:
seventh means for specifying ranges of qualifying scores and actions to be taken corresponding to each range;
eighth means for determining the range in which the qualifying score falls; and
ninth means for presenting the user with a graphical indication indicating which range the qualifying score falls.

27. The system as recited in claim 26, wherein the graphical indication comprises coloring a box containing the qualifying score on a user display with a color which indicates which of the ranges the qualifying score falls.
